(19) United States
(12) Patent Application Publication
(10) Pub. No.: US 2020/0192429 A1
(43) Pub. Date: Jun. 18, 2020

(54) KICKSTAND FOR A PORTABLE ELECTRONIC DEVICE

(71) Applicant: HEWLETT-PACKARD DEVELOPMENT COMPANY, L.P., SPRING, TX (US)

(72) Inventors: KUAN-TING WU, TAIPEI CITY (TW); YA-TING YEH, TAIPEI CITY (TW); SHIH-HSUN HUANG, TAIPEI CITY (TW)

(21) Appl. No.: 16/617,913

(22) PCT Filed: Jul. 4, 2017
(86) PCT No.: PCT/US2017/040636

§ 371 Date: Nov. 27, 2019

(51) Int. Cl. G06F 1/16; H01F 7/02

(52) U.S. Cl. CPC G06F 1/166; G06F 1/1637; G06F 1/1626; H01F 7/0252; G06F 1/1616

(57) ABSTRACT

In one example, a kickstand for a portable electronic device is disclosed which includes a body portion rotatably connected to the portable electronic device. The body portion defines at least one recess. Further, the kickstand includes at least one rubber magnet disposed within the at least one recess. The at least one rubber magnet, when located in close proximity to the portable electronic device, interacts magnetically with at least one magnetic material included within the portable electronic device.

### BACKGROUND

The emergence and popularity of mobile computing has made portable electronic devices, due to their compact design and light weight, a staple in today's marketplace. Portable electronic devices such as tablet personal computers, notebooks, convertible devices, and smartphones involve advance computing functionality and are utilized for multiples tasks such as email, internet surfing, gaming, and media capture/playback. During these times, users often place the device on a normal operating surface (e.g., desk, table, and the like) for easier operation and/or viewing.

### BRIEF DESCRIPTION OF THE DRAWINGS

Examples are described in the following detailed description and in reference to the drawings, in which:

FIG. 1A depicts a side view of an example kickstand for a portable electronic device;

FIG. 1B is a side view of an example portable electronic device depicting a closed position of the kickstand relative to a rear surface of the portable electronic device;

FIG. 1C is a rear view of the example portable electronic device depicting an open position of the kickstand relative to the rear surface of the portable electronic device;

FIG. 2A depicts a perspective view of an example portable electronic device including a kickstand;

FIG. 2B depicts a side view of the example portable electronic device of FIG. 2A, including the kickstand;

FIG. 2C is a rear view of the example portable electronic device, such as shown in FIG. 2A, depicting additional features, and

FIG. 3 is a schematic representation of an example process of manufacturing a kickstand for a portable electronic device.

### DETAILED DESCRIPTION

Portable electronic devices such as tablet personal computers, notebook computers, convertible devices, and smartphones involve advance computing functionality and are utilized for multiple tasks such as email, internet surfing, gaming, and media capture/playback. Convertible devices may refer to devices that can be “converted” from a laptop mode, where the touchpad and keyboard of the base housing is available to be used as input, to a tablet mode, where the display of the display housing may be used for both viewing and input. An example of the convertible device may include a display housing that is detachable from a base housing to operate the display housing in tablet mode. During operation, users often place the device on a normal operating surface (e.g., desk, table, and the like) for easier operation or viewing.

Further, the portable electronic device is provided with a kickstand rotatably connected to a rear surface or side walls of the display housing via hinges to support the display at multiple viewing angles. The kickstand can be extended to multiple positions to support the display at multiple viewing angles and retractable from the multiple positions to a closed position when the hinges are relaxed. In some examples, the kickstand is provided with a magnet (e.g., steel magnet bar) to enable magnetic coupling with the mating feature of the portable electronic device (e.g., outer casing formed of metal, steel, and the like) or with a corresponding magnet formed within the portable electronic device. In such cases, the kickstand with the steel magnet bar may increase the weight of the portable electronic device. Further, the kickstand may produce/cause an annoying noise when closing/retracting the kickstand with both metal parts (e.g., the kickstand and the rear surface) hitting together due to attractive magnetic force between magnetic materials provided therein.

Examples described herein may provide a kickstand for a portable electronic device. The kickstand may include a body portion rotatably connected to the portable electronic device. The body portion defines at least one recess. Further, the kickstand may include at least one rubber magnet disposed within the at least one recess. The at least one rubber magnet, when located in close proximity to the portable electronic device, interacts magnetically with at least one magnetic material comprised within the portable electronic device.

Examples described herein may replace the steel magnet bar in the kickstand with the rubber magnet, thereby reducing the weight of the portable electronic device. Further, the kickstand with the rubber magnet may eliminate the noise issue as the rubber magnet is to hit-close to metal rear housing of the portable electronic device when the kickstand is retracted. Furthermore, examples described herein may provide cost savings as the steel magnet is replaced with the rubber magnet.

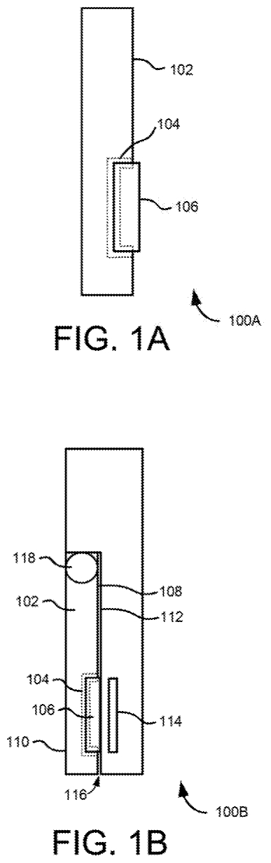

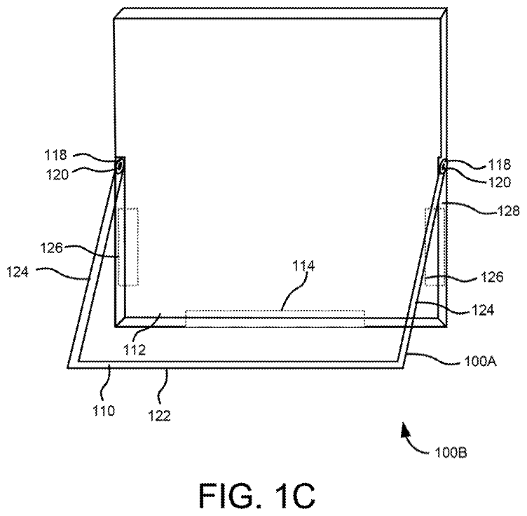

Turning now to figures, FIG. 1A depicts a side view of an example kickstand 100A for an example portable electronic device, such as shown in FIG. 1B. FIG. 1B is a side view of example portable electronic device 100B depicting a closed position of kickstand 100A relative to a rear surface 112 of portable electronic device 100B. Kickstand 100A may be rotatably connected to portable electronic device 1008 on rear surface 112 via an attachment mechanism 118. For example, attachment mechanism 118 may include hinge(s). Kickstand 100A is rotatable about an axis defined by attachment mechanism 118.

Kickstand 100A may include a body portion 102 rotatably connected to portable electronic device 1008. For example, body portion 102 is made up of a material such as stainless steel, aluminum, magnesium, titanium, zinc, or alloys thereof.

Body portion 102 may define at least one recess 104. For example, body portion 102 may have a first surface 108 and a second surface 110 opposite to first surface 108. In one example, first surface 108 may refer to a surface that abuts rear surface 112 of portable electronic device 100B when kickstand 100A is retracted. Recess 104 may be created on first surface 108 of body portion 102. In one example, recess 104 can be created using Computer Numeric Control (CNC) machining of body portion 102, but machining of body portion 102 is not limited thereto.

Further, kickstand 100A may include at least one rubber magnet 106 disposed within at least one recess 104. Rubber magnet 106, when located in close proximity to portable electronic device 100B, interacts magnetically with at least one magnetic material 114 comprised within portable electronic device 100B. Magnetic material 114 may be a material that is magnetically attracted to rubber magnet 106. Example magnetic material 114 may include iron, nickel, cobalt, steel, and the like. In another example, magnetic material 114 can be a magnet. In CNC machining, a cutting apparatus can be programmed to cut recess 104, for instance, in the shape of rubber magnet 106, to snugly receive rubber magnet 106.

For example, rubber magnet 106 may include a flexible magnet selected from a group consisting of polyisoprene, polybutadiene, chloroprene rubber, butyl rubber, styrene-butadiene rubber, nitrile rubber, hydrogenated nitrile rubber, ethylene propylene rubber (EPM), ethylene propylene diene monomer (EPDM) rubber, silicone rubber, fluorosilicone rubber, fluoroelastomers, perfluoroelastomers, polyether block amides (PEBA), chlorosulfonated polyethylene, ethylene-vinyl acetate (EVA), polysulfide rubber, thermoplastic urethane, and elastomers in combination with 5-20 wt % magnetic materials including iron, silicon steel, nickel-iron, zinc-iron, moly permalloy, iron-cobalt, ferrite, co-Steel, alnico, platinum cobalt, samarium-cobalt (SmCo), neodymium-iron-boron, cerium-iron-boron, SmFeN (i.e., referred to as iron samarium nitride, samarium iron nitrogen or samarium iron nitride and the like) and/or manganese bismuthide (MnBi).

In one example, rubber magnet 106 may extend outwardly from first surface 108 of body portion 102 to form a clearance gap 116 between abutting faces (i.e., first surface 108 and rear surface 112) of body portion 102 and portable electronic device 100B when kickstand 100A is in a closed position. For example, rubber magnet 106 may extend outwardly from first surface 108 of body portion 102 by about 0.05 mm to 0.2 mm such that rubber magnet 106 is to physically contact rear surface 112 of portable electronic device 100B when kickstand 100A is retracted.

FIG. 1C is a rear view of example portable electronic device 100B depicting an open position of kickstand 100A relative to rear surface 112 of portable electronic device 1008. Particularly, FIG. 1C depicts a U-shaped kickstand with rubber magnet disposed therein. Body portion 102 may include attachment features 120, a crossbar 122, and a pair of legs 124. Each leg 124 having a first end connected to each end of crossbar 122 to form a u-shape and a second end including one of attachment features 120 (e.g., mounting holes). In some examples, the pair of legs 124 may or may not be parallel to each other. Attachment features 120 may enable kickstand 100A to rotatably connect to portable electronic device 100B via attachment mechanism 118, for example, hinges. Recess 104 to receive rubber magnet 106 may be defined in crossbar 122.

In some examples, kickstand 100A may be provided with one rubber magnet or multiple rubber magnets. In one example, rubber magnet 106 may be disposed in crossbar 122. In this example, rubber magnet 106 disposed in crossbar 122 may interact magnetically with at least one magnetic material 114 comprised within portable electronic device 1008. In another example, rubber magnets can be disposed within each of legs 124 along with crossbar 122. In this example, rubber magnets disposed within each of legs 124 and crossbar 122 may interact magnetically with corresponding magnetic materials 126 and 114 comprised within portable electronic device 100B. Further, kickstand 100A may occupy a portion of a perimeter (e.g., slot 128 defined in the perimeter) of portable electronic device 100B when kickstand 100A is retracted.

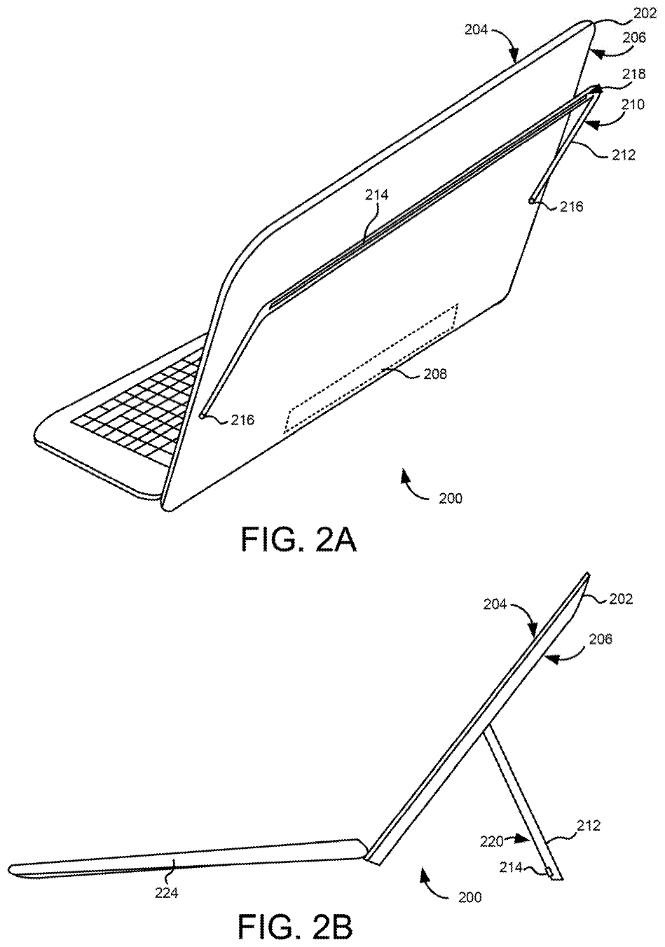

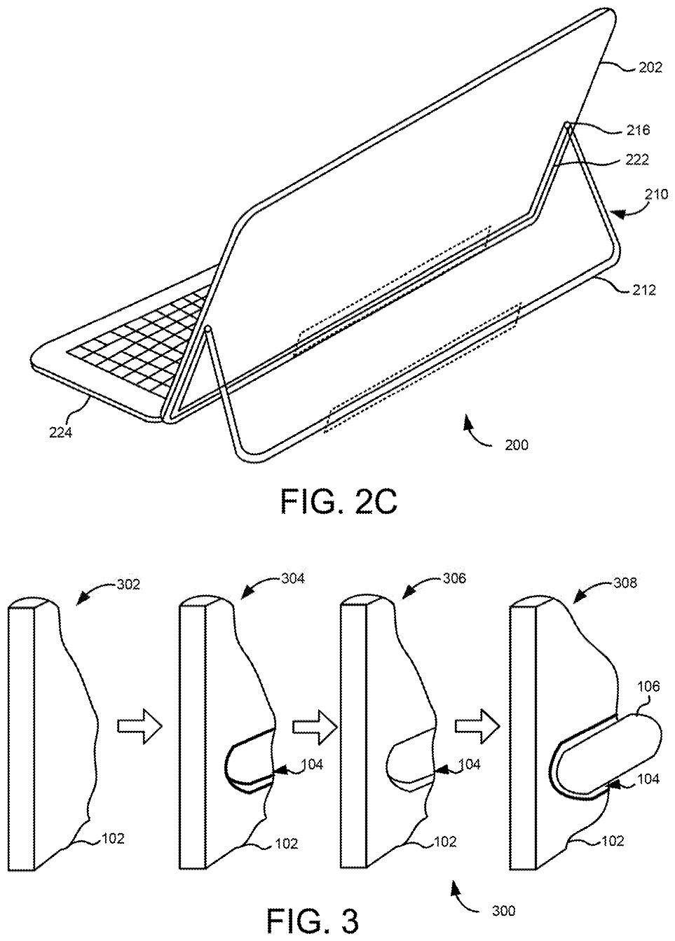

FIG. 2A depicts a perspective view of an example portable electronic device 200 including a kickstand. FIG. 2B depicts a side view of example portable electronic device 200 of FIG. 2A. FIG. 2C is a rear view of example portable electronic device 200, such as shown in FIG. 2A, depicting additional features. Example portable electronic devices may include tablet personal computers, notebooks, convertible devices, and the like.

Portable electronic device 200 may include a display housing 202 having a display surface 204 and a rear surface 206 opposite to display surface 204. For example, display may be provided on display surface 204 side. Example display can be a liquid crystal display (LCD) that permits touch interactions. Portable electronic device 200 may include a keyboard housing 224 pivotally connected to display housing 202 via hinges. Further, portable electronic device 200 may include a magnetic material 208 disposed in rear surface 206 of display housing 202. Rear surface 206 may represent a rear cover of display housing 202. In one example, rear surface 206 of display housing 202 can be made up of a metallic material that is magnetically attracted to at least one rubber magnet 214.

Portable electronic device 200 may include a kickstand 210 rotatably connected to display housing 202 on rear surface 206. For example, kickstand 210 may be rotatably connected to display housing 202 on rear surface 206 via an attachment mechanism, such as hinge(s) 216. Kickstand 210 can be outwardly rotated from rear surface 206 at an angle between 0-160°. Kickstand 210 may include a body portion 212 defining at least one recess 218. Further, kickstand 210 may include at least one rubber magnet 214 disposed within at least one recess 218. Rubber magnet 214 may interact magnetically with magnetic material 208 disposed in rear surface 206 when closing/folding kickstand 210 relative to rear surface 206 of display housing 202.

As shown in FIGS. 2A and 2B, rubber magnet 214 may be exposed on a surface 220 of body portion 212 to interact with magnetic material 208 in display housing 202. As shown in FIG. 2B, rubber magnet 214 may extend outwardly from surface 220 of body portion 212 to form a clearance gap between abutting faces (i.e., surface 220 and rear surface 206) of body portion 212 and rear surface 206 of display housing 202 when kickstand 210 is in a closed position relative to rear surface 206 of display housing 202. Rubber magnet 214 may extend outwardly from surface 220 of body portion 212 by 0.05 mm to 0.2 mm.

As shown in FIG. 2C, display housing 202 may include an opening/slot/groove 222 to accommodate kickstand 210 when kickstand 210 is closed/folded relative to rear surface 206 of display housing 202. In some examples, the opening/slot 222 may be in the shape of kickstand 210. For example, kickstand may occupy slot 222 provided in rear surface 206 of display housing 202 when kickstand 210 is retracted. In one example, portable electronic device 200 may be provided with kickstand 210 that is rotatably connected to rear surface 206 of display housing 202 via hinges 216 (e.g., as shown in FIGS. 2A-2C). In another example, portable electronic device 200 may be provided with kickstand 210 that is rotatably connected to side walls of display housing via hinges (e.g., as shown in FIGS. 1A-1C). In this example, slot 222 may be provided along the perimeter of display housing 202 to accommodate kickstand 210 when kickstand 210 is retracted. Even though examples in FIGS. 1 and 2 describe about a U-shaped kickstand, the kickstand can also be provided in any other shape such as, but not limited to, I-shape, T-shape, inverted T-shape and the like.

Even though FIGS. 1 and 2 describe about disposing the rubber magnet in the body portion of the kickstand, a flexible magnetic material, that can be magnetically attracted to a magnet, can be placed in the recess defined in the body portion and the magnet can be disposed in rear surface of display housing to facilitate the magnetic lock mechanism. Example flexible magnetic material can be made of a rubber material.

FIG. 3 is a schematic representation of an example process 300 for manufacturing a kickstand for a portable electronic device. Example portable electronic devices may include notebook computers, mobile phones, tablet computers, and the like. Kickstand may refer to a support member connected to the portable electronic device for propping up a display of the portable electronic device in a plurality of viewing angles. As an example, the kickstand may be a rectangular frame that flips out or pivots from a portion of a side walls or rear surface side of the portable electronic device and makes contact with a surface (e.g., table, desk, ground, and the like) in various positions for propping up the portable electronic device at the various viewing angles. As a result, the portable electronic device may be kept upright via the kickstand without leaning the device against another object or with the aid of a user.

At 302, a body portion (e.g., 102) may be provided, which may include a first surface and a second surface opposite to the first surface. For example, the body portion may be made up of material such as stainless steel, aluminum, magnesium, titanium, zinc, or alloys thereof. Particularly, FIG. 3 depicts a part of the body portion, such as a part of a crossbar section. At 304, a recess (e.g., 104) may be created in the body portion, for example, on the first surface. In one example, the recess in the body portion may be created using CNC machining.

At 306, a surface of the body portion defined by the recess may be electrochemically treated. For example, the surface defined by the recess may be electrochemically treated using anodization, electroplating, painting, or electrophoretic deposition.

In one example, when the body portion of the kickstand is made up of aluminum or aluminum alloy, anodization is used to electrochemically treat the surface of the body portion defined by the recess. Anodizing is an electrochemical process that converts the surface (i.e., metal surface) of the body portion into a decorative, durable, corrosion-resistant, and/or anodic oxide finish. In another example, when the body portion of the kickstand is made up of magnesium, titanium, stainless, or any alloy thereof, electroplating, painting, or electrophoretic deposition can be used to apply coatings to the metal surface of the body portion, for example, to change the surface properties of the body portion (e.g., abrasion and wear resistance, corrosion protection, lubricity, aesthetic qualities, and the like).

At 308, a rubber magnet (e.g., 106) may be disposed within the recess upon electrochemically treating the surface to form the kickstand. The rubber magnet may be exposed on the first surface of the body portion to interact magnetically with a magnetic material disposed in the display housing when the kickstand is retracted.

In one example, the rubber magnet may be disposed within the recess such that the rubber magnet extends outwardly from the surface of the body portion to form a clearance gap between abutting faces of the body portion and the display housing when the kickstand is retracted relative to a rear surface of the display housing. In one example, the rubber magnet may include a combination of magnetic material and a flexible material.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A kickstand for a portable electronic device, comprising:
a body portion rotatably connected to the portable electronic device, wherein the body portion defining at least one recess; and
at least one rubber magnet disposed within the at least one recess, wherein the at least one rubber magnet, when located in close proximity to the portable electronic device, interacts magnetically with at least one magnetic material comprised within the portable electronic device.

2. The kickstand of claim 1, wherein the at least one rubber magnet is to interact magnetically with the at least one magnetic material of the portable electronic device when closing the kickstand relative to a rear surface of the portable electronic device, and wherein the at least one magnetic material is a material magnetically attracted to the at least one rubber magnet.

3. The kickstand of claim 1, wherein the at least one rubber magnet extends outwardly from a surface of the body portion to form a clearance gap between abutting faces of the body portion and the portable electronic device when the kickstand is in a closed position.

4. The kickstand of claim 3, wherein the at least one rubber magnet extends outwardly from the surface of the body portion by 0.05 mm to 0.2 mm.

5. The kickstand of claim 1, wherein the body portion comprises:
attachment features;
a crossbar defining the at least one recess; and
a pair of legs, each leg having a first end connected to each end of the crossbar and a second end comprising one of the attachment features.

6. The kickstand of claim 1, wherein the at least one rubber magnet comprises a magnetic material in combination with a flexible material selected from a group consisting of polyisoprene, polybutadiene, chloroprene rubber, butyl rubber, styrene-butadiene rubber, nitrile rubber, hydrogenated nitrile rubber, ethylene propylene rubber (EPM), ethylene propylene diene monomer (EPDM) rubber, silicone rubber, fluorosilicone rubber, fluoroelastomers, perfluoroelastomers, polyether block amides (PEBA), chlorosulfonated polyethylene, ethylene-vinyl acetate (EVA), polysulfide rubber, thermoplastic urethane, and elastomers.

7. A portable electronic device comprising:
a display housing comprising a display surface and a rear surface opposite to the display surface;
a magnetic material disposed in the rear surface of the display housing; and
a kickstand rotatably connected to the display housing on the rear surface, wherein the kickstand comprises:
a body portion defining at least one recess; and
at least one rubber magnet disposed within the at least one recess, wherein the at least one rubber magnet interacts magnetically with the magnetic material disposed in the rear surface when closing the kickstand relative to the rear surface of the display housing.

8. The portable electronic device of claim 7, wherein the at least one rubber magnet is exposed on a surface of the body portion to interact with the magnetic material in the display housing.

9. The portable electronic device of claim 7, wherein the at least one rubber magnet extends outwardly from a surface of the body portion to form a clearance gap between abutting faces of the body portion and the rear surface of the display housing when the kickstand is in a closed position relative to the rear surface of the display housing, and wherein the at least one rubber magnet extends outwardly from the surface of the body portion by 0.05 mm to 0.2 mm.

10. The portable electronic device of claim 7, wherein the display housing comprises an opening to accommodate the kickstand when the kickstand is closed relative to the rear surface of the display housing.

11. The portable electronic device of claim 7, wherein the kickstand is rotatably connected to the display housing on the rear surface via an attachment mechanism, and wherein the attachment mechanism comprises at least one hinge.

12. A method of manufacturing a kickstand for a display housing, comprising:
creating a recess in a body portion;
electrochemically treating a surface of the body portion defined by the recess; and
disposing a rubber magnet within the recess upon electrochemically treating the surface to form the kickstand, wherein the rubber magnet is exposed on a surface of the body portion to interact magnetically with a magnetic material disposed in the display housing when the kickstand is retracted.

13. The method of claim 12, wherein disposing the rubber magnet within the recess comprises:
disposing the rubber magnet within the recess such that the rubber magnet extends outwardly from the surface of the body portion to form a clearance gap between abutting faces of the body portion and the display housing when the kickstand is retracted relative to a rear surface of the display housing.

14. The method of claim 12, wherein the body portion is made up of material comprising stainless steel, aluminum, magnesium, titanium, zinc, or alloys thereof, and wherein the recess in the body portion is created using Computer Numeric Control (CNC) machining.

15. The method of claim 12, wherein electrochemically treating the surface defined by the recess comprises anodization, electroplating, painting, or electrophoretic deposition.
